(19) United States
(12) Patent Application Publication
(10) Pub. No.: US 2018/0352990 A1
(43) Pub. Date: Dec. 13, 2018

(54) Steamer

(71) Applicant: Qinsheng Dai, Nanchang City (CN)

(72) Inventor: Qinsheng Dai, Nanchang City (CN)

(21) Appl. No.: 15/621,331

(22) Filed: Jun. 13, 2017

(51) Int. Cl. A47J 27/04; A47J 27/00

(52) U.S. Cl. CPC A47J 27/04; A47J 2027/043; A47J 27/002

(57) ABSTRACT

This invention discloses a steamer, comprising an outer wall and a steaming board received within the outer wall; and one lap of groove formed on a side wall of middle portion of the outer wall, and said groove protruding away from an inner side of the outer wall, and an edge of said steaming board received in the groove; wherein, said groove is rolled into a sheet-like convex, and the rolled groove clutches the edge of the steaming board. The present invention greatly simplifies the processing procedure of the steamer, achieving a higher manufacturing efficiency and lower cost, and the connection of the outer wall and steaming board is secure and reliable.

### TECHNICAL FIELD

The present invention relates to a food processing apparatus, especially to a steamer.

### BACKGROUND

Within the prior art, a steamer structurally comprises a seam allowance, an outer wall, and a steaming board, wherein the steaming board is mounted between the seam allowance and the outer wall. When manufacturing the steamer, the seam allowance, outer wall, and steaming board need to be pre-processed respectively first, wherein, when the seam allowance is rolled into a cylindrical shape, the peripheral joints of both sides are meshed and riveted, afterward, the upper opening edge of the seam allowance is inwardly crimped and coated with the steel bar, and the lower opening edge of the seam allowance is reamed out; and when the outer wall is rolled into a cylindrical shape, the peripheral joints of both sides are meshed and riveted, afterward, the lower opening edge of the outer wall is inwardly crimped and coated with the steel bar, and the upper opening edge of the outer wall is reamed out; and the steaming board is punched and subsequently crimped; and after the seam allowance, outer wall, and steaming board are processed, the reamed opening of the seam allowance, the crimped edge of the steaming board, and the reamed opening of the outer wall are aligned and stacked, and after multiple, repetitive processes of rolling followed by crimping, a steamer is achieved.

It can be seen that, for the existing structure of the steamer, it is troublesome to manufacture and its precision is low, furthermore the steamer formed by three parts can be easily disassembled under external force.

### SUMMARY OF THE INVENTION

The objective of the invention is to provide a steamer, aiming at solving the technical problems, such as numerous processes, high processing costs, low efficiency, and etc., caused by the steamer structure traditional design ideas mentioned in the above background.

The invention can be achieved in this way: a steamer, comprising an outer wall and a steaming board received within the outer wall; one lap of groove formed on a side wall of middle portion of the outer wall, and said groove protruding away from an inner side of the outer wall; and an edge of said steaming board received in the groove; wherein,

said groove is rolled into a sheet-like convex, and the rolled groove clutches the edge of the steaming board.

Preferably, said convex defines one lap of groove thereon by rolling.

Preferably, a top edge of said outer wall is inwardly crimped and coated with a steal bar; and a bottom edge of said outer wall is outwardly crimped and coated with a steal bar.

Preferably, said outer wall is a cylinder formed by a winded metal sheet, welded by laser.

Preferably, two opposite ends of outside of said outer wall are equipped with a handle, respectively.

Compared to the defects and deficiencies of prior art, the invention possesses the following benefits:

(1) the invention is solid and not easily disassembled under external force, due to the integration of the outer wall and seam allowance;
(2) the invention, by structural optimization, substantially simplifies traditional production process of the steamer, and reduces the tedious processing steps of traditional production process.

### BRIEF DESCRIPTION OF THE DRAWINGS

FIG. 1 is a schematic front view of the present invention;

FIG. 2 is a schematic top view of the present invention; and

FIG. 3 is a cross-sectional schematic drawing of the portion A of FIG. 1.

### DETAILED DESCRIPTION OF THE EMBODIMENTS

The present invention will be described in further detail with reference to the accompanied drawings and following embodiments, for the purpose of making the objectives, technical solutions and advantages of the present invention clearer. It shall be understood that the specific embodiments described herein are illustrative only for the invention and not intended to limit the invention.

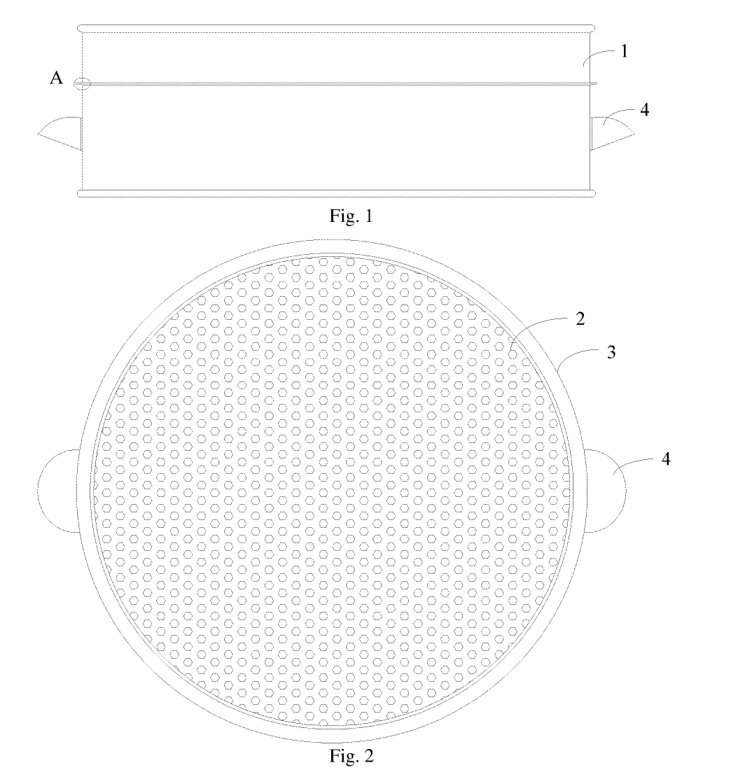

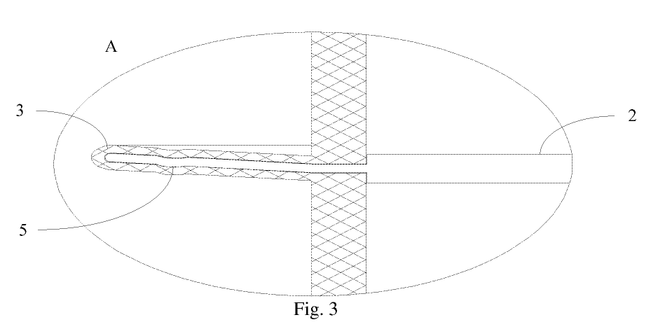

As shown in FIGS. 1-3, FIG. 1 is a schematic front view of the present invention. FIG. 2 is a schematic top view of the present invention, and FIG. 3 is a cross-sectional schematic drawing of the portion A of the FIG. 1.

The steamer includes an outer wall 1 and a steaming board 2 received within the outer wall 1, and one lap of groove is formed on a side wall of middle portion of the outer wall 1. The groove protrudes away from an inner side of the outer wall 1, and an edge of said steaming board 2 is received into the groove, wherein the groove is rolled into a sheet-like convex 3, and the rolled groove clutches the edge of the steaming board 2.

In the specific embodiment of the present invention, for common configuration, the outer wall 1 is a cylinder with its two opposite open ends, and steaming board 2 is a disc, and provided with apertures thereon, and both the outer wall 1 and steaming board 2 are formed by aluminum alloy material. In addition, to prevent the edges of the outer wall 1 from cutting the users, the top edge of said outer wall 1 is inwardly crimped, and the bottom edge of said outer wall is outwardly crimped, and both crimped edges are coated with a steal bar, respectively (view omitted from the drawings). For convenience of grasping and putting down by user, two opposite ends of outside of said outer wall 1 are equipped with a handle 4, respectively.

In the specific embodiment of the present invention, said outer wall 1 is a cylinder formed by a winded metal sheet in a square form, and the seam joint may be meshed and riveted, or may also be welded by laser. For a better strength of the steamer, the seam joint is welded by laser.

In the specific embodiment of the present invention, outer wall 1 is embedded into the groove, and the embedded portion and the non-embedded portion of the edge may be in the same horizontal plane, or may not be in the same horizontal plane, namely the joint between the embedded portion and the non-embedded portion of the edge is a flanging. In the practical application of the present invention, in order to ensure that the outer wall 1 is able to withstand a higher pressure, the embedded portion and non-embedded portion of the edge should be in the same horizontal plane, rather than forming a flanging connection.

In order to ensure a more stable connection of outer wall 1 and steaming board 2, in the specific embodiment of the present invention, said convex 3 defines one lap of groove thereon by rolling.

In the actual manufacturing process of the present invention, a square metal sheet is selected and pressed a linear groove thereon, afterward, the edge of the steaming board 2 is received into the groove, and then the metal sheet is rolled into a cylinder about the steaming board 2, and its seam joint is welded by laser, at this point, the groove is protruded away from the interior of the steamer, and when the protruded portion is squeezed, a groove 5 is formed thereon, and at this point, the steaming board 2 is fastened into the protruded portion, and after the handles 4 are installed, the steamer is finally accomplished.

The invention is solid and not easily disassembled under external force, due to the integration of outer wall and seam allowance; in addition, the invention, by structural optimization, simplifies traditional production process of the steamer, and reduces the tedious processing steps of traditional production process.

The above-described embodiments are the preferred embodiments of the present invention only, and not intended to limit the invention, and any modifications, equivalent substitutions and improvements within the spirit and principles of the invention shall be within the scope of the present invention.

What is claimed is:

1. A steamer, comprising:
an outer wall and a steaming board received within the outer wall, wherein one lap circle of a groove is formed on a portion of the outer wall, wherein the groove protrudes away from an inner side of the outer wall, and an edge of the steaming board is received within the groove;
wherein the groove is rolled into a sheet-like convex, and the rolled groove clutches the edge of the steaming board.

2. The steamer according to claim 1, wherein the sheet-like convex defines one lap of groove thereon by rolling.

3. The steamer according to claim 2, wherein a top edge of the outer wall is inwardly crimped and coated with a steal bar; and a bottom edge of the outer wall is outwardly crimped and coated with a steal bar.

4. The steamer according to claim 3, wherein said outer wall is a cylinder formed by a winded metal sheet, welded by laser.

5. The steamer according to claim 4, wherein two opposite ends of outside of said outer wall are equipped with a handle, respectively.
